(19) United States
(12) Patent Application Publication
(10) Pub. No.: US 2026/0200784 A1
(43) Pub. Date: Jul. 16, 2026

(54) APPARATUS FOR GLASS MANUFACTURING

(71) Applicant: Corning Incorporated, Corning, NY (US)

(72) Inventors: Rashid Abdul-Rahman, Livermore, CA (US); Jinsoo Kim, Asan (KR); Brian Michael Palmer, Corning, NY (US); Ilya Svyatogorov, Espoo (FI)

(21) Appl. No.: 19/133,358

(22) PCT Filed: Nov. 13, 2023
(86) PCT No.: PCT/US2023/037185

§ 371 Date: May 28, 2025

Related U.S. Application Data
(60) Provisional application No. 63/428,481, filed on Nov. 29, 2022.

(51) Int. Cl. C03B 7/07; C03B 5/167; C03B 7/084

(52) U.S. Cl. CPC C03B 7/07; C03B 5/1675; C03B 7/084

(57) ABSTRACT

A glass manufacturing apparatus is disclosed. The glass manufacturing apparatus includes a conduit defining a length. The conduit includes an interior passage defining a conduit cross-sectional footprint with a first cross-sectional area at a point along the length. The apparatus further includes an expansion drum positioned along the length of the conduit or adjacent to and in line with the conduit. The expansion drum defines an expansion drum cross-sectional footprint and a length. The expansion drum cross-sectional footprint extends outside of the conduit cross-sectional footprint. The expansion drum includes a second cross-sectional area at a second point along the length of the conduit. The second cross-sectional area is greater than the first cross-sectional area. The apparatus may further include one or more reinforcing members attached to and extending along a portion of the length of the conduit.

### CROSS-REFERENCE TO RELATED APPLICATION

This application claims the benefit of priority under 35 U.S.C. § 119 of U.S. Provisional Application Ser. No. 63/428,481 filed on Nov. 29, 2022, the content of which is relied upon and incorporated herein by reference in its entirety.

### FIELD

Embodiments of the present disclosure relate generally to apparatuses for forming molten glass, and more particularly to conduits for conveying the molten glass. Method of forming the molten glass are also described.

### BACKGROUND

Manufacturing apparatuses for forming molten glass typically include conduits configured to convey the molten glass from one component of the apparatus to another component. For example, a conduit can extend between a melting vessel and a downstream component such as a stirring vessel. The conduit may be configured with crimps formed by deforming (e.g., bending) the metal against a die (which may result in thinning portions of the walls) to provide radial stiffness in the radial direction along the length of the conduit. However, these crimps may introduce multiple failure points within the conduit, such as due to structural thinning which may induce a greater oxidation rate as compared to the non-crimped portions of the conduit.

Notably, to maintain and increase the temperature of the molten glass, electrical current may be delivered to the conduit via one or more electrical flanges attached to and in electrical communication with the conduit. The electrical current travels through the conduit between electrical flanges and heats the conduit by Joule heating, which in turn heats the molten glass therein. Such Joule heating can, for example, be used to control a viscosity of the molten glass in preparation for the downstream forming process. The temperature, however, increases at portions of reduced thickness (such as at the crimps) thereby increasing oxidation at that portion, which in turn leads to further thinning of the (already reduced) portion.

Because of the high temperature and corrosive nature of molten glass, many components of the manufacturing apparatus are formed from temperature and corrosion resistant metals. These components, including the crimps, are often thin-walled owing to the expense of these metals. For certain glasses, processing temperatures can be near the melting temperature of the metal. Because the metal may be very thin, and be exposed to high temperatures, the component structures may therefore lack significant strength and be prone to failure, such as by collapsing over time.

### SUMMARY

Embodiments of the present disclosure are directed toward glass manufacturing apparatus comprising conduits that have radial and/or lateral support to maintain structural integrity as molten glass flows therethrough. The glass manufacturing apparatus may comprise a conduit having one or more reinforcing members attached external to the conduit to provide such support. Additionally, at least one expansion drum may be positioned along the length of the conduit either adjacent to the conduit or in line with the conduit and configured for thermal expansion of the glass manufacturing apparatus during temperature fluctuations, e.g., during heat up and cool down of the apparatus.

Use of at least one expansion drum and/or reinforcing members allow the conduit to have a uniform wall thickness, as the at least one expansion drum can mitigate strain due to thermal expansion.

Some embodiments of the present disclosure may further comprise a casting, e.g., a refractory casting, surrounding the conduit and configured to support the conduit. Molten glass may flow through the conduit and exert pressure on the casting due to the weight of the molten glass. In this regard, the casting can help prevent deformation of the conduit by supporting the conduit. In some embodiments, the casting may support top portions of the conduit, above the flow of the molten glass, by engaging with one or more reinforcing members. The reinforcing members may be shaped to be retained within the casting such that the conduit maintains the desired conduit shape and does not collapse onto the molten glass flow.

In an example embodiment, the glass manufacturing apparatus comprises a conduit configured to carry a flow of molten glass therethrough, the conduit having a length and an interior passage defining a conduit cross-sectional footprint with a first cross-sectional area at a first position along the length of the conduit. The apparatus further comprises an expansion drum positioned along the length of the conduit. The expansion drum defines an expansion drum cross-sectional footprint with a second cross-sectional area at a second position. The second cross-sectional footprint may be parallel to the first cross-sectional footprint. The expansion drum cross-sectional footprint extends outside of the conduit cross-sectional footprint. That is, the second cross-sectional area of the expansion drum at the second position is greater than the first cross-sectional area of the conduit at the first position such that a distance from a central longitudinal axis of the expansion drum to a periphery of the expansion drum is greater than a distance from a central longitudinal axis of the conduit to a periphery of the conduit. The central longitudinal axis of the expansion drum may be parallel to and coaxial with the central longitudinal axis of the conduit. The apparatus may further comprise a reinforcing member attached to and extending along a portion of the length of the conduit.

In some embodiments, the apparatus may further comprise an electrical flange attached to the expansion drum. In some embodiments, the expansion drum may comprise a first expansion drum and a second expansion drum, and the reinforcing member may extend between the first expansion drum and the second expansion drum.

In some embodiments, the reinforcing member may comprise a first reinforcing member and a second reinforcing member. The first reinforcing member and the second reinforcing member may be spaced at least 30 degrees apart over a third of a periphery of the conduit. In some embodiments, the first reinforcing member and the second reinforcing member may be symmetrical about an apex of the periphery of the conduit. In some embodiments, the first reinforcing member and the second reinforcing member may be spaced apart by 120 degrees or less. In some embodiments, the apparatus may further comprise a third reinforcing member. The third reinforcing member may comprise a third member length, the first reinforcing member may comprise a first member length and the second reinforcing member may define a second member length. The third member length may be different than the first member length and the second member length. In some embodiments, the reinforcing member may comprise at least one nonlinear portion.

The apparatus may further comprise a casting, e.g., a refractory casting, surrounding the conduit. The at least one nonlinear portion of the reinforcing member may engage with the casting. For example, the at least one reinforcing member may extend into the casting and be anchored therein. In some embodiments, the conduit of the apparatus may comprise platinum. For example, the conduit may comprise a platinum alloy such as a platinum rhodium alloy.

In another example embodiment, a glass manufacturing apparatus is provided. The glass manufacturing apparatus comprises a conduit comprising a length. The conduit further comprises an interior passage defining a conduit cross-sectional area at a first position along the length. The interior passage being configured to carry a flow of molten glass therethrough. The system further comprises at least one expansion drum positioned at the first position. The at least one expansion drum defines an expansion drum cross-sectional footprint with a second cross-sectional area at the first position. The expansion drum cross-sectional footprint extends outside of the conduit cross-sectional footprint. The second cross-sectional area is greater than the first cross-sectional area. The apparatus may further comprise a casting disposed about the conduit. The system further comprises at least one reinforcing members attached to and extending along a portion of the length of the conduit. The at least one reinforcing members are engaged in the casting.

In some embodiments, the apparatus may further comprise an electrical flange attached to or circumscribing a periphery of the at least one expansion drum. The electrical flange extends through the casting.

In some embodiments, the at least one reinforcing member may comprise a first section and a second section. The first section may extend on a first side of the at least one expansion drum and the second section may extend on a second side of the at least one expansion drum. In some embodiments, the at least one reinforcing member may comprise at least a first reinforcing member and a second reinforcing member. The first reinforcing member and the second reinforcing member may be positioned between 30 degrees and 120 degrees apart. In some embodiments, the at least one reinforcing member may be positioned on a portion of the conduit above a glass line of the flow of molten glass.

In yet another example embodiment, an apparatus for manufacturing glass is disclosed. The apparatus may comprise a first conduit extending between a first expansion drum and a second expansion drum, the first conduit comprising an interior passage configured to carry a flow of molten glass therethrough. The first conduit defines a first cross-sectional area at a first position along a length of the first conduit. The first expansion drum defines a second cross-sectional area at a second position along a length of the first expansion drum. The second expansion drum defines a third cross-sectional area at a third position along a length of the second expansion drum. The second cross-sectional area is greater than the first cross-sectional area, and the third cross-sectional area is greater than the first cross-sectional area. The apparatus may further comprise a first electrical flange connected about the first expansion drum, and a second electrical flange connected about the second expansion drum.

In some embodiments, the apparatus may further comprise a reinforcing member attached to the first conduit and extending at least partially between the first expansion drum and the second expansion drum. For example, the reinforcing member may comprise at least a first reinforcing member and a second reinforcing member positioned between about 30 degrees and about 120 degrees apart. In some embodiments, the apparatus may further comprise a second conduit attached to one of the first expansion drum or the second expansion drum. In some embodiments, the conduit may comprise platinum.

In yet another example embodiment, a glass manufacturing apparatus is provided. The glass manufacturing apparatus comprises a conduit comprising a length, the conduit comprising an interior passage configured to carry a flow of molten glass therethrough. The glass manufacturing apparatus may further comprise a plurality of reinforcing members extending along a portion of the length of the conduit and peripherally spaced about the conduit.

In some embodiments, the reinforcing members may comprise a first reinforcing member and a second reinforcing member, the first reinforcing member and the second reinforcing member positioned between about 30 degrees and about 120 degrees apart.

### BRIEF DESCRIPTION OF THE DRAWINGS

Having thus described the disclosure in general terms, reference will now be made to the accompanying drawings, which are not drawn to scale, and wherein:

FIG. 1 is a schematic view of an exemplary glass manufacturing apparatus, in accordance with some embodiments discussed herein;

FIGS. 2A-C illustrate cross sectional views of a conduit for conveying molten glass as (a) initially placed in service (FIG. 2A), (b) after time operating at high temperature wherein an upper portion of the conduit undergoes collapse (FIG. 2B), and (c) wherein collapse is sufficiently large to cause the collapsed top of the conduit to contact the free surface (e.g., glass line) of the molten glass therein, effectively isolating an airspace at one end of the conduit from an airspace at another end of the conduit (FIG. 2C), in accordance with some embodiments discussed herein;

FIG. 3 illustrates a schematic longitudinal cross-section of an example conduit illustrated in FIG. 2A, in accordance with some embodiments discussed herein;

FIG. 4 illustrates an example glass manufacturing apparatus, in accordance with some embodiments discussed herein;

FIG. 5A illustrates a perspective view of a cross-section of the example glass manufacturing apparatus of FIG. 4 taken across line A-A, in accordance with some embodiments discussed herein;

FIG. 5B illustrates a perspective cross-sectional view of the example glass manufacturing apparatus of FIG. 4 taken across like B-B, in accordance with some embodiments discussed herein;

FIG. 5C illustrates a schematic cross-sectional view of the example glass manufacturing apparatus of FIG. 4 taken across line C-C, in accordance with some embodiments discussed herein;

FIG. 6A illustrates a cross-sectional footprint of the conduit shown in FIG. 4 taken across line A-A, in accordance with some embodiments discussed herein;

FIG. 6B illustrates a cross-sectional footprint of the expansion drum shown in FIG. 4 taken across line B-B, in accordance with some embodiments discussed herein;

FIG. 6C illustrates a schematic cross-sectional view of an example expansion drum, in accordance with some embodiments discussed herein;

FIGS. 7A-D illustrate cross-sectional views of example configurations of reinforcing members, in accordance with some embodiments discussed herein;

FIGS. 8A-D illustrate top views of example configurations of reinforcing members, in accordance with some embodiments discussed herein;

FIGS. 9A-D illustrate example profile configurations of the reinforcing members, in accordance with some embodiments discussed herein; and

FIG. 10 illustrates a flow chart of an example method regarding glass manufacturing, in accordance with some embodiments discussed herein.

### DETAILED DESCRIPTION

Some example embodiments will now be described more fully herein with reference to the accompanying drawings, in which some, but not all example embodiments are shown. Indeed, the examples described and pictured herein should not be construed as being limiting to the scope, applicability or configuration of the present disclosure. Rather, these example embodiments are provided so that this disclosure will satisfy applicable legal requirements. Like reference numerals refer to like elements throughout.

Directional terms as used herein—for example, up, down, right, left, front, back, top, bottom—are made only with reference to the figures as drawn and are not intended to imply absolute orientation.

As used herein, the term conduit refers generally to a structure defining a hollow interior configured to convey molten glass therethrough. Conduits may be configured for conveyance purposes or structured to perform additional functions. For example, conduits may be configured for removing gases from molten glass, and, although they may be referred to as fining assemblies or fining vessels herein, such fining assemblies or fining vessels nevertheless may belong generically to the family of conduits.

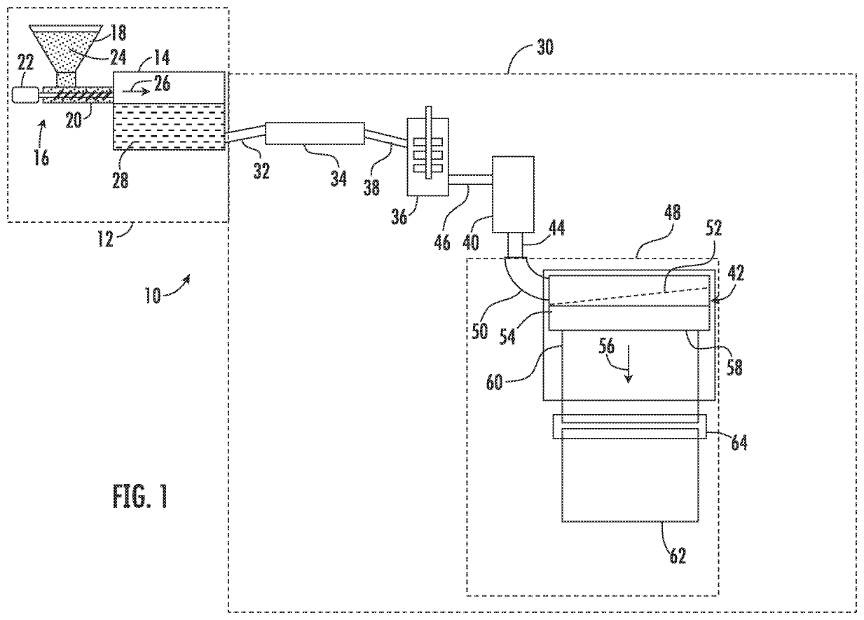

Shown in FIG. 1 is an exemplary glass manufacturing apparatus 10. The glass manufacturing apparatus 10 comprises a glass melting furnace 12 including a melting vessel 14. In addition to the melting vessel 14, the glass melting furnace 12 can optionally include one or more additional components such as heating elements (e.g., combustion burners and/or electrodes) configured to heat raw material 24 and convert the raw material 24 into a molten material, hereinafter, molten glass. For example, the melting vessel 14 may be an electrically boosted melting vessel, wherein energy may be added to the raw material 24 through both combustion burners and by direct heating (e.g., an electrical current is passed through the raw material 24, the electrical current thereby adding energy via Joule heating of the raw material 24).

The glass melting furnace 12 may include other thermal management devices (e.g., thermal insulation components) that reduce heat loss from the melting vessel. The glass melting furnace 12 can include electronic and/or electromechanical devices that facilitate melting of the raw material 24 into a glass melt. The glass melting furnace 12 can include support structures (e.g., support chassis, support member, etc.) or other components.

The melting vessel 14 may be formed from a refractory material, for example a refractory ceramic material comprising alumina or zirconia, although the refractory ceramic material can comprise other refractory materials, such as yttrium (e.g., yttria, yttria-stabilized zirconia, yttrium phosphate), zircon (ZrSiO₄) or alumina-zirconia-silica or even chrome oxide, used either alternatively or in any combination. In some examples, the melting vessel 14 may be constructed from refractory ceramic bricks.

The glass melting furnace 12 may be incorporated as a component of a glass manufacturing apparatus 10 configured to fabricate a glass article, for example a glass ribbon 60, although the glass manufacturing apparatus 10 may be configured to form other glass articles without limitation, such as glass rods, glass tubes, glass envelopes (for example, glass envelopes for lighting devices, e.g., light bulbs) and glass lenses. In some examples, the melting furnace 12 may be included in a glass manufacturing apparatus 10 comprising a slot draw apparatus, a float bath apparatus, a down-draw apparatus (e.g., a fusion down-draw apparatus), an up-draw apparatus, a pressing apparatus, a rolling apparatus, a tube drawing apparatus or any other glass manufacturing apparatus that would benefit from the present disclosure. By way of example, FIG. 1 schematically illustrates the glass melting furnace 12 as a component of a fusion down-draw glass manufacturing apparatus 10 for fusion drawing a glass ribbon for subsequent processing into individual glass sheets or rolling the glass ribbon onto a spool. As used herein, fusion drawing comprises flowing molten glass over inclined, e.g., converging, side surfaces of a forming body, wherein the resulting streams of molten material join, or “fuse,” at the bottom of the forming body to form a ribbon 60.

The glass manufacturing apparatus 10 may optionally include an upstream glass manufacturing apparatus 16 positioned upstream of the melting vessel 14. In some examples, a portion of, or the entire upstream glass manufacturing apparatus 16, may be incorporated as part of the glass melting furnace 12.

As shown in FIG. 1, upstream glass manufacturing apparatus 16 may include a raw material storage bin 18, a raw material delivery device 20, and a motor 22 connected to the raw material delivery device 20. The raw material storage bin 18 can be configured to store raw material 24 that can be fed into the melting vessel 14 of the glass melting furnace 12 through one or more feed ports, as indicated by arrow 26. The raw material 24 typically comprises one or more glass forming metal oxides and one or more modifying agents. In some examples, the raw material delivery device 20 may be powered by the motor 22 to deliver a predetermined amount of the raw material 24 from the raw material storage bin 18 to the melting vessel 14. In further examples, the motor 22 may power the raw material delivery device 20 to introduce the raw material 24 at a controlled rate based on a level of molten glass 28 sensed downstream from the melting vessel 14 relative to a flow direction of the molten glass 28. The raw material 24 within the melting vessel 14 may thereafter be heated to form the molten glass 28. Typically, the raw material 24 is added to the melting vessel 14 as particulate, for example as various “sands.” The raw material 24 may also include scrap glass (i.e., cullet) from previous melting and/or forming operations. In some embodiments, combustion burners may be used to begin the melting process. In an electrically boosted melting process, once the electrical resistance of the raw material 24 is sufficiently reduced by the combustion burners, electric boost can begin by developing an electrical potential between electrodes positioned in contact with the raw material 24, thereby establishing an electrical current through the raw material 24, the raw material 24 typically entering, or in, a molten state.

The glass manufacturing apparatus 10 may also include a downstream glass manufacturing apparatus 30 positioned downstream of the glass melting furnace 12 relative to a flow direction of molten glass 28. In some examples, a portion of the downstream glass manufacturing apparatus 30 may be incorporated as part of the glass melting furnace 12. For example, a first connecting conduit 32 discussed below, or other portions of the downstream glass manufacturing apparatus 30, may be incorporated as part of the glass melting furnace 12.

The downstream glass manufacturing apparatus 30 may include a first conditioning apparatus, such as a fining vessel 34 located downstream from the melting vessel 14 and coupled to the melting vessel 14 by way of the above-referenced the first connecting conduit 32. In some examples, molten glass 28 may be gravity fed from the melting vessel 14 to the fining vessel 34 by way of an interior pathway of the first connecting conduit 32. Accordingly, the first connecting conduit 32 provides a flow path for molten glass 28 from the melting vessel 14 to the fining vessel 34. However, other conditioning chambers may be positioned downstream of the melting vessel 14, for example between the melting vessel 14 and the fining vessel 34. In some embodiments, a conditioning chamber may be employed between the melting vessel 14 and the fining vessel 34. For example, molten glass from a primary melting vessel can be further heated in a secondary melting (conditioning) vessel or cooled in the secondary melting vessel to a temperature lower than the temperature of the molten glass in the primary melting vessel before entering the conditioning chamber 34.

Bubbles may be removed from molten glass 28 by various techniques. For example, the raw material 24 may include multivalent compounds (e.g., fining agents) such as tin oxide that, when heated, undergo a chemical reduction reaction and release oxygen. Other suitable fining agents can include without limitation arsenic, antimony, iron, and/or cerium, although the use of arsenic and antimony, owing to their toxicity, may be discouraged for environmental reasons in some applications. The fining vessel 34 may be heated, for example to a temperature greater than the melting vessel 14 interior temperature, thereby heating the fining agent. Oxygen produced by the temperature-induced chemical reduction of one or more fining agents included in the molten glass 28 may diffuse into gas bubbles produced during the melting process. The enlarged gas bubbles with increased buoyancy then rise to a glass line of the molten glass 28 within the fining vessel 34 and can thereafter be vented from the fining vessel 34, for example through a vent tube in fluid communication with the atmosphere above the glass line, wherein the glass line is the surface of molten glass between the flow of the molten glass and the gaseous atmosphere above the flow of molten glass.

The downstream glass manufacturing apparatus 30 may further include another conditioning chamber, such as mixing apparatus 36, for example a stirring vessel, for mixing the molten glass that flows downstream from the fining vessel 34. The mixing apparatus 36 may be used to provide a homogenous glass melt composition, thereby reducing chemical and/or thermal inhomogeneities that may otherwise exist within the molten glass exiting the fining vessel 34. As shown, the fining vessel 34 may be coupled to the mixing apparatus 36 by way of a second connecting conduit 38. Accordingly, molten glass 28 may be gravity fed from the fining vessel 34 to the mixing apparatus 36 through an interior pathway of second connecting conduit 38. For instance, gravity may drive molten glass 28 from the fining vessel 34 to the mixing apparatus 36. Typically, the molten glass within the mixing apparatus 36 includes a glass line, with a free (e.g., gaseous) volume extending between the glass line and a top of the mixing apparatus 36. While mixing apparatus 36 is shown downstream of the fining vessel 34 relative to a flow direction of molten glass 28, the mixing apparatus 36 may be positioned upstream from the fining vessel 34 in other embodiments. In some embodiments, the downstream glass manufacturing apparatus 30 may include multiple mixing apparatus, for example a mixing apparatus upstream from the fining vessel 34 and a mixing apparatus downstream from the fining vessel 34. When used, multiple mixing apparatus may be of the same design, or they may be of a different design from one another. One or more of the vessels and/or conduits may include static mixing vanes positioned therein to promote mixing and subsequent homogenization of the molten material.

The downstream glass manufacturing apparatus 30 may further include another conditioning chamber such as a delivery vessel 40 located downstream from the mixing apparatus 36. The delivery vessel 40 may act as an accumulator and/or flow controller to adjust and/or provide a consistent flow of molten glass 28 to a forming body 42 by way of exit conduit 44. The molten glass 28 within the delivery vessel 40 may, in some embodiments, include a glass line, wherein a free volume extends upward from the glass line to a top of the delivery vessel 40. As shown, the mixing apparatus 36 may be coupled to the delivery vessel 40 by way of third connecting conduit 46. In some examples, the molten glass 28 may be gravity fed from the mixing apparatus 36 to the delivery vessel 40 through an interior pathway of the third connecting conduit 46.

The downstream glass manufacturing apparatus 30 may further include a forming apparatus 48 comprising the above-referenced forming body 42, including inlet conduit 50. An exit conduit 44 may be positioned to deliver molten glass 28 from the delivery vessel 40 to the inlet conduit 50 of the forming apparatus 48. The forming body 42 in a fusion down-draw glass making apparatus can comprise a trough 52 positioned in an upper surface of the forming body 42 and opposing converging forming surfaces 54 that converge in a draw direction 56 along a bottom edge (root) 58 of the forming body 42. The molten glass 28 delivered to the forming body trough 52 via the delivery vessel 40, the exit conduit 44 and the inlet conduit 50 overflows the walls of the trough 52 and descends along the converging forming surfaces 54 as separate flows of molten glass. The separate flows of molten glass join below and along the root 58 to produce a ribbon 60 of molten glass that is drawn in draw direction 56 from root 58 by applying a downward tension to the glass ribbon, such as by gravity and/or counter-rotating and opposing pulling rolls. The downward tension and the temperature of the molten material may be used to control dimensions of the ribbon 60 (hereafter glass ribbon) as the molten material cools and a viscosity of the material increases. Accordingly, the glass ribbon 60 goes through a viscosity transition, from a viscous state to a viscoelastic state to an elastic state and acquires mechanical properties that give the glass ribbon 60 stable dimensional characteristics. The glass ribbon 60 may be separated into shorter lengths, such as into glass sheets 62, by a glass separating apparatus 64. Alternatively, the glass ribbon 60 may be spooled.

Components of the downstream glass manufacturing apparatus 30, including any one or more of connecting conduits 32, 38, 46, the fining vessel 34, the mixing apparatus 36, the delivery vessel 40, the exit conduit 44, or the inlet conduit 50 may be formed from a precious metal. Suitable precious metals include platinum group metals selected from the group consisting of platinum, iridium, rhodium, osmium, ruthenium and palladium, or alloys thereof. For example, downstream components of the glass manufacturing apparatus may be formed from a platinum-rhodium alloy including from about 70% to about 90% by weight platinum and about 10% to about 30% by weight rhodium.

For certain components of the glass manufacturing apparatus 10, particularly those metal components operated at high temperature, e.g., in excess of about 1300° C., for example in excess of 1400° C., in excess of about 1500° C., in excess of about 1600° C., or even in excess of about 1700° C., but less than the melting point of the metal component, structural integrity of the component may be compromised by the high temperature to which the component is subjected and the thinness of the component. That is, platinum, and other platinum group metals (and/or alloys thereof), are expensive. Accordingly, components incorporating these metals (e.g., including any one or more of the connecting conduits 32, 38, 46, the fining vessel 34, the mixing apparatus 36, the delivery vessel 40, the exit conduit 44, or the inlet conduit 50) may be made with thin walls to reduce expense, (e.g., having a thickness equal to or less than about 0.254 cm). Pure platinum, for example, has a melting temperature of 1768° C. In some optical-quality glass making apparatus, such as those intended for alumino-silicate glasses such as glass substrates used in the manufacture of optical display devices, a platinum-containing component may be operated in excess of 1600° C., or even in excess of 1700° C., very near the melting temperature of platinum. One such example is the fining vessel 34, a specialized metal conduit used to remove gases (e.g., gas bubbles) from the molten glass. The fining vessel 34 may be operated partially unfilled. That is, a gaseous atmosphere is maintained over a glass line of the molten glass 28, providing a region within the fining vessel 34 where gases removed from the molten glass 28 can accumulate and be vented from the fining vessel 34. However, at least because this gaseous atmosphere is less efficient at eliminating heat from the fining vessel 34 than the molten glass in contact with the lower portion of the fining vessel 34, the upper portion of the fining vessel 34 may become hotter than the lower portion. Additionally, the gaseous atmosphere provides less mechanical and/or hydraulic support than a comparable conduit completely filled with molten glass. Over time, gravity may cause the upper portion of the fining vessel 34 to slump downward, narrowing the internal passageway of the fining vessel 34. This collapse may lead to increased resistance to the flow of molten glass through the fining vessel 34 and possible structural failure thereof (e.g., a breach of the fining vessel). Other vessels, e.g., connecting conduits described herein, may also suffer from such outcomes for these or other reasons.

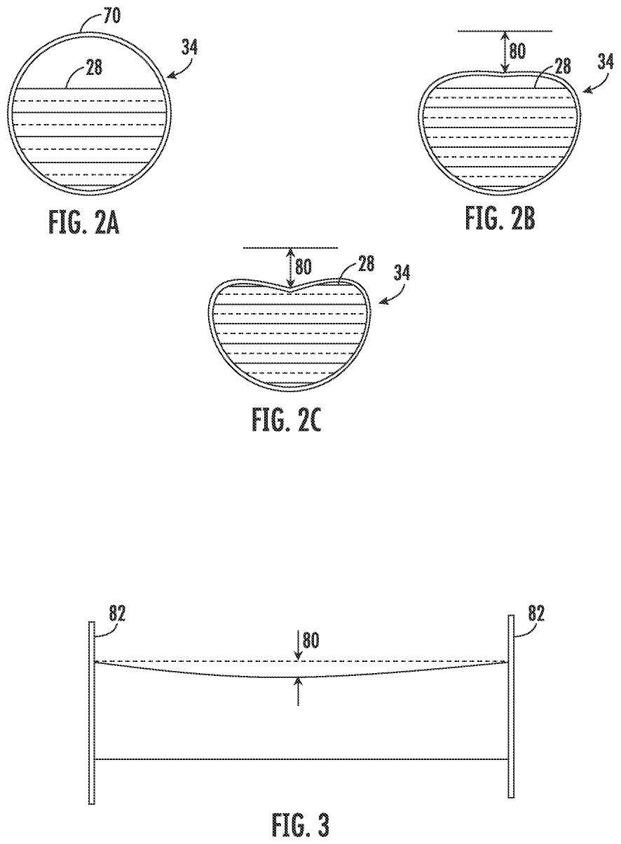

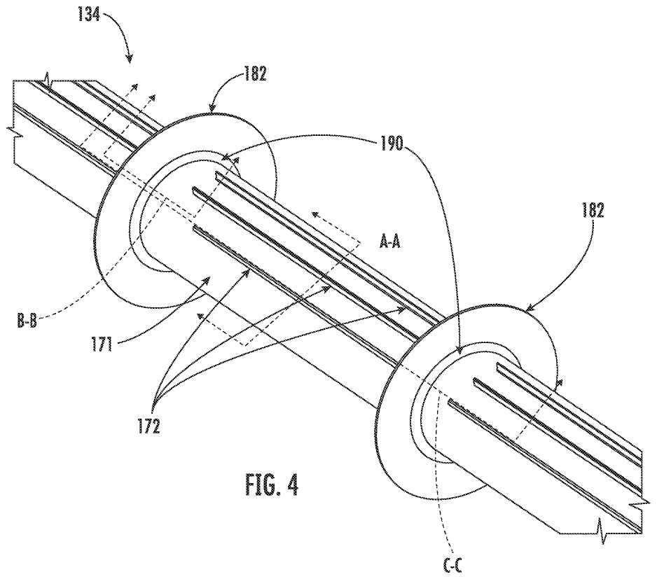

By way of example, FIGS. 2A-C depict multiple cross-sectional views of an exemplary fining vessel 34 (in a plane orthogonal to a longitudinal axis) shown at multiple points in time, e.g., (a) at the beginning of a melting operation (FIG. 2A), and (b) and (c) after an extended time in operation (FIGS. 2B and 2C, respectively), for example, after 10,000 hours of operation. FIG. 3 is a longitudinal cross-sectional view of the fining vessel 34 of FIG. 2C for example. The exemplary fining vessel 34 in FIG. 2A is depicted comprising a wall 70 defining an initial circular cross-sectional shape. However, in some embodiments, the fining vessel 34 could have other initial cross-sectional shapes, such as an elliptical shape, an oval shape, another curvilinear shape, or other shape. The figures illustrate a downward displacement 80 of the upper portion of the fining vessel 34 in FIG. 2B, after an extended time (e.g., 10,000 hours) of operation at the molten glass 28 processing temperature. In some instances, as depicted in FIG. 2C, downward displacement 80 may be sufficiently large that the collapsed top of the fining vessel 34 contacts the molten glass 28 conveyed therein. In the view of FIG. 3, ends of the fining vessel 34 may be supported by electrical flanges 82 extending around a circumference of the fining vessel 34 and positioned along the length of the fining vessel, for example at ends of the fining vessel, preventing collapse of the fining vessel 34 at the supported portions such that maximum displacement occurs at or near the unsupported portion(s) of the fining vessel 34, farthest from the electrical flanges 82. The electrical flanges are connected to electrical power supplies that provide the electrical flanges with an electrical current, the electrical current extends through the flanges and is distributed to the fining vessel about a circumference thereof. Accordingly, an electrical current is established in the fining vessel wall between the electrical flanges that heats the fining vessel by Joule heating. Other metal conduits within the glam manufacturing apparatus may be similarly heated.

Autopsies conducted on fining vessels 34 taken out of service have shown collapses of the upper portion in a range from about 18 millimeters (mm) to greater than 24 mm are possible over long periods of high temperature operation. As suggested by FIG. 2C, if collapse of the top of the fining vessel 34 is sufficiently large, the top of the fining vessel 34 may contact the molten glass 28. Proper operation of the fining vessel 34 relies on maintaining a volume free of molten glass 28 within the fining vessel 34 and above a glass line of molten glass 28 that forms a reservoir in which gases removed from the molten glass 28 can accumulate and be vented from the fining vessel 34. The venting relies on free gaseous communication throughout this upper molten glass-free volume of the fining vessel 34, for example between two electrical flanges 82. If, for example, a vent is located at one end of the fining vessel 34, and fining vessel 34 collapse results in the fining apparatus top wall contacting the molten glass 28, this contact may isolate one portion of the molten glass-free volume from another portion of the molten glass-free volume, thereby preventing the free flow of gases through the molten glass-free volume and preventing venting of accumulated gasses. That is, collapse of the upper wall portion of the fining vessel 34 into contact with the molten glass 28 can form isolated pockets of gas within the fining vessel 34 that are cut off from the fining apparatus vent and therefore unable to escape the fining vessel 34. Such trapped gas can redissolve into the molten glass or build up pressure within the fining apparatus that leads to failure of the fining vessel 34.

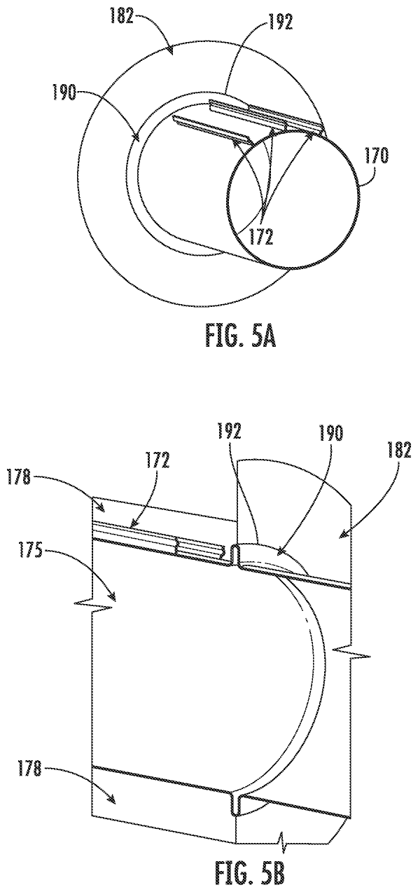

As described, the glass manufacturing apparatus may comprise multiple components. FIG. 4 illustrates an example conditioning apparatus 134, which is a component of the glass manufacturing apparatus in accordance with some embodiments discussed herein. The conditioning apparatus 134 may be designed to reduce and/or alleviate failure points associated with wall thinning and pressure build ups within the molten glass and the conduit due to the high operating temperatures as discussed above.

In some embodiments, the conditioning apparatus 134 may comprise a conduit 171, defined by a wall 170. In some embodiments, the conduit 171 may comprise a circular cross-section, while in other embodiments, conduit 171 may have other cross-sectional shapes, such as an elliptical shape, an oval shape, another curvilinear shape, or other shape. In this regard, the term circumference should be understood to mean the perimeter or periphery of the conduit 171, and the diameter should be understood to mean a measure, for example, of a chord length across the conduit 171.

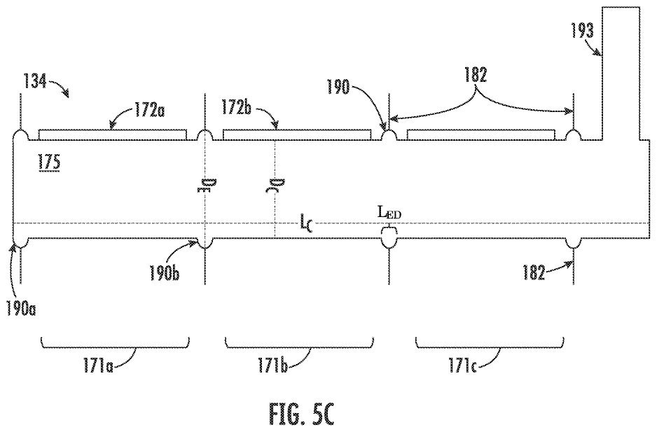

One or more reinforcing members 172 may be attached to the external portion of the conduit extending along the length of the conduit 171. The conditioning apparatus 134 may further include at least one expansion drum 190 formed within the conduit 171 or positioned adjacent to and in-line (e.g., coaxial) with the conduit 171 (shown, for example, in FIG. 5B).

In some embodiments, the conduit 171 may define a length (see e.g., Lc FIG. 5C), extending between the first connecting conduit (e.g., 32 FIG. 1) and the second connecting conduit (e.g., 38 FIG. 1). The conduit 171 comprises an interior passage 175 (see e.g., FIG. 5A for a perspective view of the interior passage) configured to carry molten glass through the conditioning apparatus 134.

As described above, in some embodiments, the conditioning apparatus 134 may comprise a fining vessel wherein the molten glass flows through the fining vessel and releases gas bubbles as a fining material is chemically reduced. In some embodiments, the conditioning apparatus 134 may comprise an electrical flange 182 attached to the at least one expansion drum 190, wherein the electrical flange 182 may be in electrical communication with a power supply to heat the conduit 171 and therefore the molten glass flowing therethrough. In some embodiments, the one or more reinforcing members 172 may be configured to provide structural support to the conduit 171 (e.g., aid in the conduit 171 retaining its desired footprint).

FIG. 5A illustrates a perspective view of a portion of the conditioning apparatus 134 shown in FIG. 4 taken across line A-A. In some embodiments, a casting 178 may surround the conduit 171 (shown in FIG. 5B). The casting may be molded about the conduit 171 by pouring a slurry about the conduit 171 and solidifying the slurry. In some embodiments, the casting 178 may be a refractory material (e.g., a ceramic refractory material). In this regard, the casting 178 may provide support for the lower portion of the conduit 171 due to pressure from the molten glass, while the one or more reinforcing members 172 may secure the upper portion of the conduit 171 within the casting 178.

In some embodiments, the one or more reinforcing members 172 may be attached (e.g., welded) to the conduit 171 while, in other embodiments, the one or more reinforcing members 172 may be formed integral to the conduit 171. In some embodiments, as will be discussed further herein, the one or more reinforcing members 172 may be nonlinear such as to engage with e.g., be anchored within, the casting 178, thereby providing support along the length (e.g., Lc) of the conduit 171. In this regard, the nonlinear portion of the one or more reinforcing members 172 may include a bend, a curve, a corner, or similar feature such that it deviates from a straight line.

In some embodiments, with further reference to FIG. 5B, the electrical flange 182 may be connected to the at least one expansion drum 190 at a connection interface 192. In some embodiments, the connection may be formed by welding, or a mechanical connection.

In some embodiments, the casting 178 may encapsulate the at least one expansion drum 190 and a portion of the electrical flange 182, while in other embodiments the casting 178 may abut, but not contact the at least one expansion drum 190. In some embodiments, the casting 178 may be positioned to abut the at least one expansion drum 190 such that the expansion drum 190 may expand and/or contract with temperature fluctuations of the conduit 171.

In some embodiments, the casting 178 may be molded to engage the one or more reinforcing members 172 such that the contour of the one or more reinforcing members may be retained within the casting 178, thereby providing radial and lateral support along the length Lc of the conduit 171.

FIG. 5B illustrates a perspective cross-sectional view of the conditioning apparatus 134 of FIG. 4 taken along line B-B. In some embodiments, the at least one expansion drum 190 may be configured to relieve strain created during heat up and/or due to temperature fluctuation within the conduit 171 during operation. As explained herein, the at least one expansion drum is configured to replace crimps on the interior of the conduit 171.

As noted above, in prior fining vessels that utilized crimps, the crimps were formed by deforming the metal against a die and, due to the deformation, portions of the conduit were thinned. In this regard, the interior passage comprised a varying wall thickness along the length of the conduit. Thus, when an electrical current was applied to the electrical flange to heat the conduit, the thinner portions of the conduit would heat faster and to a higher temperature as compared to the surrounding metal. As discussed, temperature is one of the main drivers of oxidation. Thus, the crimps provided a cycle where the thinner portions of the conduit 171 would heat faster in comparison to the thicker parts of the conduit 171. The increase in the temperature increased the oxidation rate, thereby causing the material to further thin. The cycle then repeated until the conduit 171 failed due to either collapse of the conduit 171 or rupture of the conduit 171.

In contrast, the at least one expansion drum 190 may be designed to handle the temperature fluctuation of the molten glass, thereby alleviating the need for interior crimps. Using the expansion drum(s) instead of crimps means the wall of the conduit 171 may comprise a uniform wall thickness along the length Lc of the conduit 171. Thus, the uniformity may allow the conduit wall to heat evenly, thereby limiting oxidation along parts in the conduit wall.

FIG. 5C illustrates a cross-sectional view of the conditioning apparatus 134 shown in FIG. 4 taken along line C-C. In some embodiments, the conduit 171 may comprise multiple portions, for example a first conduit portion 171a, a second conduit portion 171b, and a third conduit portion 171c. In some embodiments, each of the conduit portions 171a, 171b, 171c may be spaced apart from one another by an expansion drum. In this regard, in some embodiments, the at least one expansion drum 190 may comprise a first expansion drum 190a and a second expansion drum 190b, etc.

In some embodiments, the one or more reinforcing members 172 may comprise at least a first section 172a and a second section 172b. In some embodiments, the first section 172a may correspond to and be attached to the first conduit portion 171a, and the second section 172b may correspond to and be attached to the second conduit portion 171b. In some embodiments, the first section 172a may extend between the first expansion drum 190a and the second expansion drum 190b, and the second section 172b may extend after the second expansion drum 190b on the side of the second expansion drum 190b opposite the first section 172a.

In some embodiments, the first section 172a may extend partially on the first conduit portion 171a, while in other embodiments, the first section 172a may extend along the entire length of the first conduit portion 171a. In some embodiments, the first section 172a may extend partially between the first expansion drum 190a and the second expansion drum 190b, while in other embodiments, the first section 172a may extend completely between the first expansion drum 190a and the second expansion drum 190b.

The conditioning apparatus 134 may encompass different configurations. For example, the first expansion drum 190a may connect the conditioning apparatus 134 to the first connection conduit (e.g., 32 FIG. 1). As another example, the first conduit portion 171a may be connected to the first connection conduit (e.g., 32 FIG. 1). In some embodiments, the conditioning apparatus 134 may comprise one expansion drum, two expansion drums, or three or more expansion drums. In some embodiments, the conditioning apparatus 134 may comprise an equal number of conduit portions and expansion drums, while in other embodiments the conditioning apparatus 134 may comprise a greater number of conduit portions than expansion drums, or a greater number of expansion drums than conduit portions.

In some embodiments, the conditioning apparatus 134 may comprise a vent 193 within the conduit 171. The vent 193 may be configured to allow gases generated within the conditioning apparatus 134 to be removed to prevent over pressuring of the conduit vessel, or potential reintroduction into the molten glass. In some embodiments, the conduit 171 may comprise a single vent 193, while in other embodiments the conduit 171 may comprise more than one vent 193.

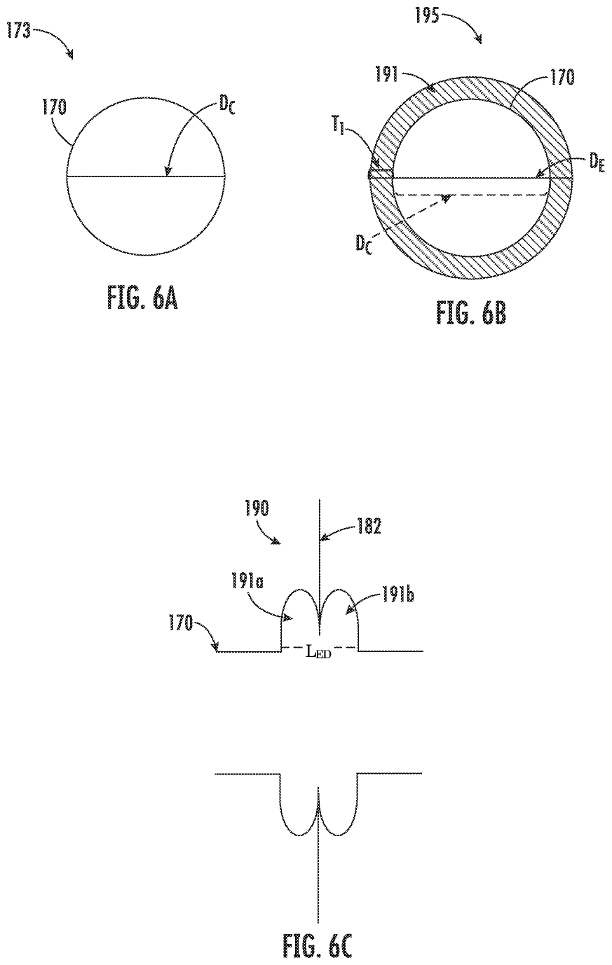

Components of the conditioning apparatus 134 may exhibit different profiles, each of which may contribute to the efficiency of the glass manufacturing apparatus. For example, the conduit 171 may exhibit a constant conduit diameter D_{C} along the length Lc of the conduit 171. In some embodiments, the interior passage 175 of the conduit 171 may define a conduit cross-sectional footprint 173 with a first cross-sectional area (shown in FIG. 6A). In this regard, as discussed, the conduit cross-sectional footprint 173 may be constant along the length Lc of the conduit 171 as the conduit 171 exhibits a constant conduit diameter D_{C} and wall thickness. Although diameter is used herein, it should be understood that the diameter may be a chord length between two opposing points on the conduit or the expansion drum.

In contrast to the conduit 171, the at least one expansion drum 190 may comprise variable diameters along an expansion drum length LED, the expansion drum length extending in the length direction of the conduit. To explain, the diameter of the at least one expansion drum at the transition between the conduit 171 and the at least one expansion drum 190 may be equal to the conduit diameter D_{C}, while the diameter of the at least one expansion drum 190 at an apex (e.g., connection interface 192) may be an expansion drum diameter D_{E}, where the expansion drum diameter D_{E} is the largest diameter of the expansion drum. The expansion drum diameter D_{E} is larger than the conduit diameter D_{C}.

Thus, the at least one expansion drum 190 may define an expansion drum cross-sectional footprint 195 illustrated in FIG. 6B. The expansion drum cross-sectional footprint 195 defines a second cross-sectional area, wherein the expansion drum cross-sectional footprint 195 and the second cross-sectional area are variable along the expansion drum length LED by a thickness T₁. In this regard, the expansion drum cross-sectional footprint 195 may fluctuate, however, the expansion drum cross-sectional footprint 195 extends outside of the conduit cross-sectional footprint 173.

In some embodiments, as illustrated in FIG. 6C, the at least one expansion drum 190 may comprise a first expansion drum 191a and a second expansion drum 191b, wherein the first expansion drum 191a is adjacent the second expansion drum 191b. In some embodiments, the electrical flange 182 may be positioned over each of the first expansion drum 191a and the second expansion drum 191b. Although illustrated as rounded cavities, the at least one expansion drum 190 may be of any shape.

In some embodiments, the one or more reinforcing members 172 may be configured to provide radial support to the conduit 171. Rather than utilizing crimps, struts or other similar features which extend about the periphery of the conduit, the one or more reinforcing members 172 may extend along the length of the conduit Lc to provide radial support. For example, the one or more reinforcing members 172 may be configured to engage with a casting (e.g., 178 FIG. 5B) surrounding the conduit 171. The casting may provide support to both the lower portion of the conduit and the upper portion of the conduit.

To explain, the molten glass may exert pressure on the lower portion of the conduit (e.g., where the molten glass flows and contacts the conduit) and the casting may be configured to support the lower portion of the conduit. In contrast, as described above, the upper portion (e.g., above the glass line 128 of the molten glass) does not exert pressure on the casting. Thus, to support the upper portion of the casting the one or more reinforcing members 172 may be configured to engage with the casting to retain the shape of the upper portion of the conduit, thereby preventing the conduit from collapsing into the molten glass. Additionally, the spacing of the one or more reinforcing members may evenly support the upper portion of the conduit, such that the conduit maintains the desired conduit shape along the length of the conduit so that adequate free space is maintained above the glass line 128 of the molten glass.

In an example embodiment, the system may be designed such that the flow of molten glass occurs through the lower half of the conduit 171. Thus, the glass line 128 of the molten glass may flow through the center of the conduit (e.g., at the conduit diameter D_{C} FIG. 6A) and may be set at an appropriate height within the conduit 171. Accordingly, the one or more reinforcing members 172 may be positioned on an upper half of the conduit 171. In other embodiments, the system may be designed such that the flow of the molten glass occurs through the bottom two-thirds of the conduit, thus, the one or more reinforcing members 172 may be positioned on an upper third of the conduit 171.

In some embodiments, the one or more reinforcing members 172 may be positioned above the flow of the molten glass. The wall 170 of the conduit 171 may be thin and therefore unable to support the weight of the molten glass flowing within the internal passage 175, particularly at operating temperatures. In this regard, the casting 178, and any additional refractory material about the casting 178, are unable to support the top portion of the conduit 171 as there is no pressure from the molten glass at the top of the conduit due to the free space above the glass line 128 of the molten glass. Thus, over time, with sufficient temperature, the top portion of the conduit 171 may slump, as discussed previously.

To maintain the thinness of the wall 170, and thereby save the amount of material used to support the conduit 171, the one or more reinforcing members 172 may be positioned on an exterior of the conduit wall, away from the molten glass. In such a configuration, the one or more reinforcing members support the conduit to prevent the upper portion of the conduit 171 from collapsing. However, in other embodiments, the one or more reinforcing members 172 may be positioned about the entire perimeter of the conduit cross-sectional footprint 173.

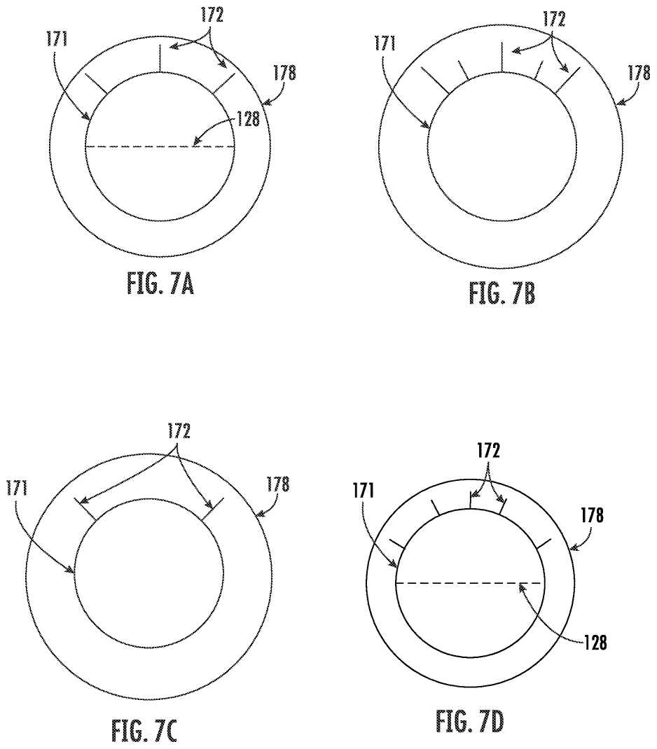

FIGS. 7A-D illustrate cross-sectional views of the conduit 171 and the casting 178 that illustrate various configurations of the one or more reinforcing members 172. In some embodiments, the one or more reinforcement member 172 may be one or more members, two or more members, three or more members, four or more members, or five or more members. In some embodiments, the number of reinforcing members 172 may correspond to various factors including flow rate (e.g., to determine the size of the vessel), the density of the molten glass, temperature of the molten glass, etc.

In some embodiments, the one or more reinforcing members may be symmetrical about the conduit footprint and may be positioned even with or above the glass line 128 of the molten glass. For example, the one or more reinforcing members 172 may be spaced apart by 150 degrees or less, by 120 degrees or less, or, for example, by 90 degrees or less when measured from a center of the conduit 171. In some embodiments, the outermost reinforcing members (e.g., closest along the periphery to the glass line 128) may be spaced apart by 150 degrees or less, by 120 degrees or less, or, for example, by 90 degrees or less. In some embodiments, the location of the glass line 128 of the molten glass may push against the conduit wall, and thereby the casting, which may influence support from the casting on the conduit at the glass line 128. In this regard, since at the glass line 128 the molten glass is supporting the conduit 171, the placement of the one or more reinforcing members may be based on the position of the glass line 128 of the molten glass.

In some embodiments, illustrated in FIG. 7A the conduit 171 may comprise three reinforcing members 172. When an odd number of reinforcing members is utilized, one of the reinforcing members may be positioned along an apex (center top) of the conduit 171, for example, at a 12 o'clock position. Each of the remaining reinforcing members 172 may be separated by 60 degrees or less, 45 degrees or less, 30 degrees or less, or even 15 degrees or less from the 12 o'clock reinforcing member.

In some embodiments, each of the reinforcing members 172 may have the same height when measured radially from the wall 170 of the conduit 171. Additionally, each of the reinforcing members 172 may extend the same distance into the casting 178. In some embodiments, the reinforcing members may extend into the casting at least 20% of the thickness of the casting, at least 40% of the thickness of the casting, or even into at least 60% of the thickness of the casting. A greater extension distance of the one or more reinforcement members 172 into the thickness of the casting 178 may provide greater support, thereby further inhibiting collapse of the conduit 171. However, the one or more reinforcing members 172 may have different heights, and therefore extend into different thicknesses of the casting 178. For example, the reinforcing members closest to the glass line 128 may extend 20% into the thickness of the casting, while the reinforcing member at or adjacent to the apex of the conduit 171 (e.g., farthest from the glass line) may extend 40% into the thickness of the casting 178.

In some embodiments, such as shown in FIG. 7B, the one or more reinforcing members 172 may be five reinforcing members. In some embodiments, the five reinforcing members may be separated by 30 degrees from an adjacent reinforcing member, while in other embodiments, the reinforcing members may be separated by 22.5 degrees or less from an adjacent reinforcing member, as illustrated in FIG. 7B.

In some embodiments, such as shown in FIG. 7C, the one or more reinforcing members 172 may be two reinforcing members separated by 90 degrees. In some embodiments, the two reinforcing members 172 may be spaced apart by no more than 120 degrees, no more than 100 degrees, or no more than 90 degrees.

In some embodiments, as illustrated in FIGS. 7A-C, the one or more reinforcing members 172 may be evenly spaced in relation to one another about a portion of the periphery of the conduit 171. However, as shown in FIG. 7D, the spacing between the one or more reinforcing members 172 may be variable. To explain, the apex of the conduit (e.g., farthest point from the glass line 128 containing gaseous material) may require more support than the conduit portions in line (e.g., coincident) with the glass line 128. Thus, in some embodiments the reinforcing members 172 may be spaced closer together around the apex and may be spaced farther apart closer to the glass line 128, as illustrated in FIG. 7D.

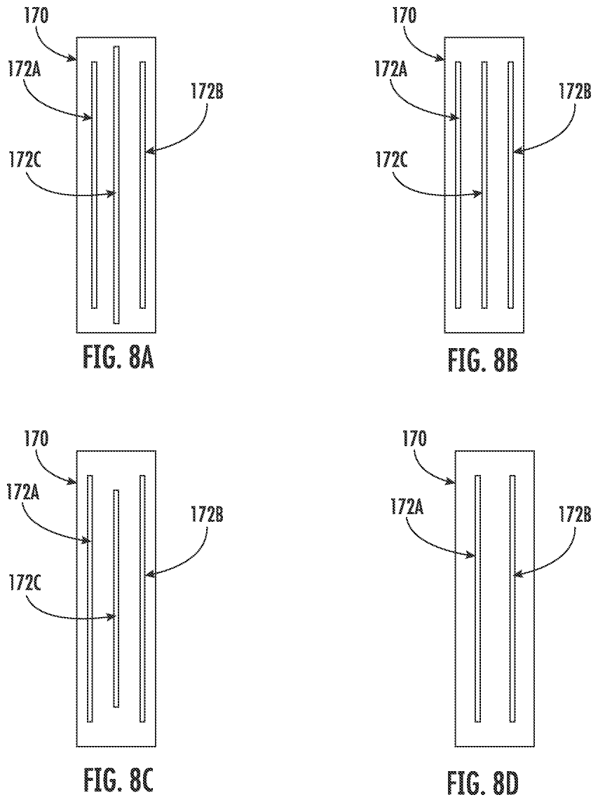

In some embodiments, the one or more reinforcing members 172 attached to the wall 170 of the conduit may have different lengths, as illustrated in FIGS. 8A-D. For example, a first reinforcing member 172A and a second reinforcing member 172B may have a first length, and a third reinforcing member 172C may have a second length. In some embodiments, such as shown in FIGS. 8A and 8C, the first length and the second length may be different. In other embodiments, such as shown in FIG. 8A, the first length may be greater than the second length, while in still other embodiments, such as shown in FIG. 8C, the first length may be less than the second length. However, as shown in FIG. 8B, the first length and the second length may be equal. FIG. 8D illustrates another example embodiment where only two reinforcing members (a first reinforcing member 172A and a second reinforcing member 172B) are used, and the two reinforcing members have equal length.

In some embodiments that utilize a first reinforcing member 172A and a second reinforcing member 172B, each reinforcing member may have the first length. In some embodiments, the reinforcing members 172A, 172B, 172C may be symmetrical about the periphery of the conduit (such as relative to an apex of the conduit as described herein).

As discussed above, the one or more reinforcing members 172 may be configured to engage with the casting (e.g., 178 FIG. 7A) such that the engagement supports the conduit to maintain the conduit shape. Thus, in some embodiments, the connection between the one or more reinforcing members and the conduit 171 may be linear along the conduit, and the one or more reinforcing members 178 may be secured within the casting with protrusions or perforations to cause the casting to engage the one or more reinforcing members.

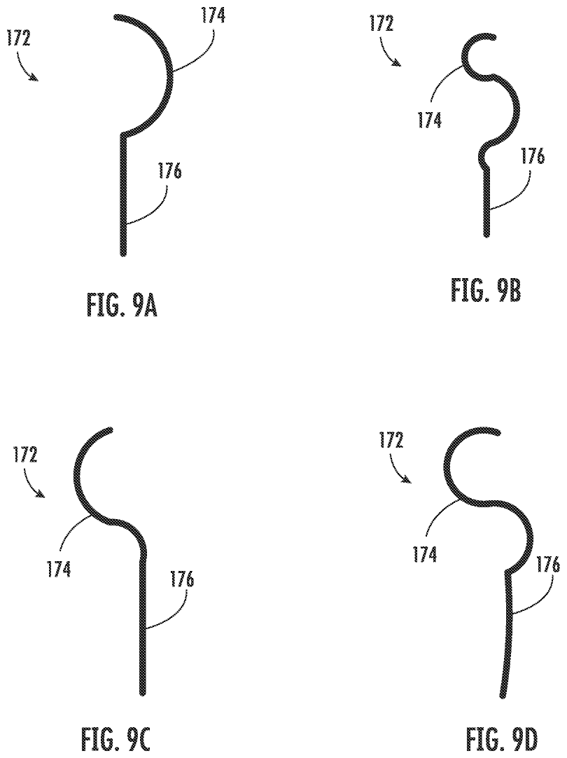

In some embodiments, the nonlinear portions may be configured to engage with the casting. For example, in some embodiments, the one or more reinforcing members may comprise nonlinear portions. To explain, as illustrated in FIGS. 9A-C, the one or more reinforcing members 172 may comprise different shapes that incorporate an upper portion 174, e.g., a nonlinear upper portion, engaged with the casting, and a lower portion 176, e.g., a linear lower portion, attached to the conduit, although in other embodiments, the upper portion 174 may be connected to the conduit. In some embodiments, such as illustrated in FIG. 9D, the upper portion 174 and the lower portion 176 may each be nonlinear, and each of the upper portion 174 and the lower portion 176 may exhibit distinct nonlinear configurations. The casting may be formed about the reinforcing member such that the casting is continuous about the reinforcing member. Accordingly, the casting and the reinforcing members may exert force on one another, thereby holding the upper portion of the conduit in place, inhibiting collapse, and maintaining the conduit shape.

In some embodiments, the nonlinear portion 174 may comprise a hook shape disposed on the end of the reinforcing member 172, while the linear portion 176 may be configured to be attached to the conduit. In some embodiments, the nonlinear portion 174 may comprise a bend, a curve, a hook, or similarly shaped object.

### Example Flowchart(s)

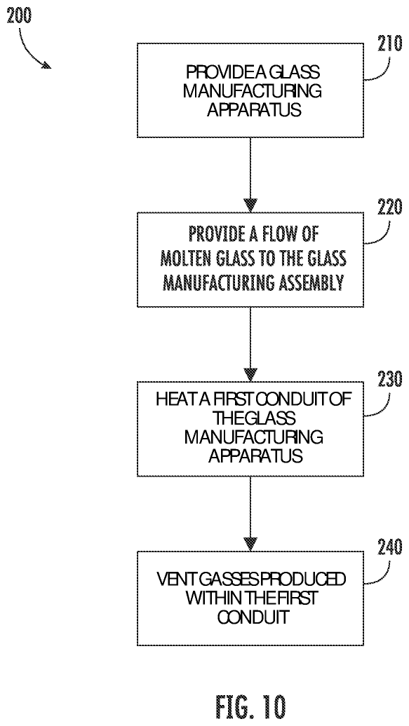

FIG. 10 is a flowchart illustrating an example method 200 for conditioning molten glass with a conditioning apparatus, in accordance with at least some embodiments discussed herein. At operation 210, a glass manufacturing apparatus is provided (e.g., assembled and/or positioned). In some embodiments, the glass manufacturing apparatus may include a conditioning apparatus, for example a fining vessel. At operation 220, a flow of molten glass is provided to the glass manufacturing apparatus. In some embodiments, the flow of molten glass may be continuous. At operation 230, a first conduit of the glass manufacturing apparatus is heated. The first conduit may be heated by applying an electrical current to an electrical flange such that the electrical current extends through the first conduit to heat the first conduit to a temperature greater than the temperature of the molten glass. During the heating, fining agents within the molten glass may be reduced due to the temperature and produce oxygen gas that may be incorporated into bubbles within the molten glass due to the low partial pressure of oxygen within the bubbles. At operation 240, the gas removed from the molten glass may be vented from the first conduit.

Notably, the above operations for FIG. 10, while described in a certain order, may be performed in a different order and/or some of the operations may be performed simultaneously. Accordingly, unless otherwise expressly stated, it is in no way intended that any method set forth herein be construed as requiring that its steps be performed in a specific order, nor that with any apparatus, specific orientations be required.

It will therefore be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure without departing from the substance or scope of the disclosure. Accordingly, while the present disclosure has been described herein in detail in relation to various embodiments, it is to be understood that this disclosure is only illustrative and is made merely for purposes of providing a full and enabling description. The foregoing disclosure is not intended or to be construed to limit or otherwise to exclude other embodiments, adaptations, variations, modifications and equivalent arrangements.

1. A glass manufacturing apparatus, comprising:
a conduit comprising a first length, the conduit further comprising an interior passage defining a conduit cross-sectional footprint with a first cross-sectional area at a first position along the length; and
an expansion drum positioned at a second position along the length of the conduit, the expansion drum defining an expansion drum cross-sectional footprint parallel with the first cross-sectional footprint and a second cross-sectional area greater than the first cross-sectional area.

2. The glass manufacturing apparatus of claim 1, wherein the conduit comprises a reinforcing member attached to and extending along a portion of the length of the conduit.

3. The glass manufacturing apparatus of claim 1, further comprising an electrical flange attached to the expansion drum.

4. The glass manufacturing apparatus of claim 2, wherein the expansion drum comprises a first expansion drum and a second expansion drum adjacent the first expansion drum, and the reinforcing member extends between the first expansion drum and the second expansion drum.

5. The glass manufacturing apparatus of claim 4, wherein the reinforcing member comprises a first reinforcing member and a second reinforcing member, the first reinforcing member and the second reinforcing member spaced at least 30 degrees apart over one third of a periphery of the conduit.

6. The glass manufacturing apparatus of claim 5, wherein the first reinforcing member and the second reinforcing member are symmetrical about an apex of the periphery of the conduit.

7. The glass manufacturing apparatus of claim 5, wherein the first reinforcing member and the second reinforcing member are spaced apart by 120 degrees or less.

8. The glass manufacturing apparatus of claim 5, further comprising a third reinforcing member, the third reinforcing member comprising a third member length, the first member comprising a first member length, the second member comprising a second member length, and wherein the third member length is different than the first member length and the second member length.

9. The glass manufacturing apparatus of claim 2, wherein the reinforcing member comprises at least one nonlinear portion.

10. The glass manufacturing apparatus of claim 9, further comprising a casting disposed around the conduit, the at least one nonlinear portion of the reinforcing member engaged with the casting.

11. The glass manufacturing apparatus of claim 1, wherein the conduit comprises platinum.

12. A glass manufacturing apparatus comprising:
a conduit comprising an interior passage defining a conduit cross-sectional footprint with a first cross-sectional area at a first position along a length of the conduit, the interior passage configured to carry a flow of molten glass therethrough;
at least one expansion drum positioned at a second position along the length, the at least one expansion drum defining an expansion drum cross-sectional footprint with a second cross-sectional area at the second position greater than the first cross-sectional area, the expansion drum cross-sectional footprint extending outside of the conduit cross-sectional footprint;
a casting disposed about the conduit; and
at least one reinforcing member attached to and extending along a portion of the length of the conduit, the at least one reinforcing member engaged in the casting.

13. The glass manufacturing apparatus of claim 12, further comprising an electrical flange attached to or circumscribing a periphery of the at least one expansion drum.

14. The glass manufacturing apparatus of claim 12, wherein the at least one reinforcing member comprises a first section and a second section, the first section extending on a first side of the at least one expansion drum, and the second section extending on a second side of the at least one expansion drum.

15. The glass manufacturing apparatus of claim 12, wherein the at least one reinforcing member comprises a first reinforcing member and a second reinforcing member positioned between 30 degrees and 120 degrees apart from the first reinforcing member.

16. The glass manufacturing apparatus of claim 12, wherein the at least one reinforcing member is positioned on a portion of the conduit above a glass line of the flow of molten glass.

17. A glass manufacturing apparatus, comprising:
a first conduit extending between a first expansion drum and a second expansion drum, the first conduit comprising an interior passage configured to carry a flow of molten glass therethrough, the first conduit defining a first cross-sectional area at a first position along a length of the first conduit, the first expansion drum defining a second cross-sectional area greater than the first cross-sectional area at a second position along a length of the first expansion drum, and the second expansion drum defining a third cross-sectional area greater than the first cross-sectional area at a third position along a length of the second expansion drum;
a first electrical flange connected about the first expansion drum; and
a second electrical flange connected about the second expansion drum.

18. The glass manufacturing apparatus of claim 17, further comprising a reinforcing member attached to the first conduit and extending at least partially between the first expansion drum and the second expansion drum.

19. The glass manufacturing apparatus of claim 18, wherein the reinforcing member comprises at least a first reinforcing member and a second reinforcing member positioned between about 30 degrees and about 120 degrees apart.

20. The glass manufacturing apparatus of claim 17 further comprising a second conduit attached to the first expansion drum or the second expansion drum.
